(19) United States
(12) Patent Application Publication
(10) Pub. No.: US 2023/0110007 A1
(43) Pub. Date: Apr. 13, 2023

(54) ASSESSING IF RECORDS FROM DIFFERENT DATA SOURCES REPRESENT A SAME ENTITY

(71) Applicant: International Business Machines Corporation, Armonk, NY (US)

(72) Inventors: Martin Anton Oberhofer, Sindelfingen (DE); Lars Bremer, Boeblingen (DE); Basem Elasioty, Regensburg (DE); Hemanth Kumar Babu, Böblingen (DE); Thuany Karoline Stuart, Nice (FR)

(21) Appl. No.: 17/489,844

(22) Filed: Sep. 30, 2021

(51) Int. Cl. G06F 16/2457; G06Q 10/10

(52) U.S. Cl. CPC G06F 16/24578; G06Q 10/1097

(57) ABSTRACT

In an approach, a processor receives a first record from a first data source, where the first record comprises attributes, a second record from a second data source, where the second record comprises said attributes, a first individual quality rating for the attributes of the first record, and a second individual quality rating for the attributes of the second record. A processor, in response to inputting the first record and the second record into a probabilistic matching engine, receives a matching score for each of the respective attributes. A processor calculates a weighted matching score for each of the respective attributes by weighting the matching score for each of the respective attributes with the first individual quality rating and the second individual quality rating. A processor assesses whether the first record and the second record represent the same entity based on the weighted matching score.

### BACKGROUND

The present invention relates to data record assessment, and more specifically, to assessing whether a first record and a second record represent the same entity.

Assessing if two records represent the same entity is important for data systems where the data originates from different data sources can be difficult. For example, before records are deposited in a master data management (MDM) system, the records may draw data from a number of sources and undergo a number of transformations or processes. Two records which represent the same entity may have attributes with different content.

### SUMMARY

According to one embodiment of the present invention, a computer-implemented method, computer program product, and computer system are provided. A processor receives a first record from a first data source, where the first record comprises attributes. A processor receives a second record from a second data source, where the second record comprises said attributes. A processor receives a first individual quality rating for the attributes of the first record. A processor receives a second individual quality rating for the attributes of the second record. A processor, in response to inputting the first record and the second record into a probabilistic matching engine, receives a matching score for each of the attributes of the first record and the attributes of the second record. A processor calculates a weighted matching score for each of the attributes of the first record and the attributes of the second record by weighting the matching score for each of the respective attributes with the first individual quality rating and the second individual quality rating. A processor assesses whether the first record and the second record represent the same entity based on the weighted matching score.

### BRIEF DESCRIPTION OF THE DRAWINGS

In the following embodiments of the invention are explained in greater detail, by way of example only, making reference to the drawings in which:

FIG. 1 illustrates an example of a computer system;

FIG. 2 shows an example computing environment in which the computer system of FIG. 1 is connected;

FIG. 3 illustrates a further example of a computer system;

FIG. 4 shows a flow chart which illustrates an approach of operating the computer system of FIG. 3;

FIG. 5 illustrates several data lineage graphs; and

FIG. 6 illustrates an example of a system, in accordance with an embodiment of the present invention.

### DETAILED DESCRIPTION

The descriptions of the various embodiments of the present invention will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The use of the weighted matching score may provide for a more robust and accurate determination if the first record and the second record represent the same entity. Using the first individual quality rating and the second individual quality rating to calculate the weighted matching score provides a means of giving portions of the data which have a higher quality (greater degree in confidence that it is correct) more influence in determining if the first record and the second record do in fact represent the same entity. This may for example have the benefit of reducing the number of false matches between the first record and the second record. An additional benefit may be that less computational resources are needed because the number of false matches is reduced.

In another embodiment the approach further comprises calculating an average matching score by averaging at least a subset of the weighted matching scores for each of said attributes. In some examples the weighted matching score can be averaged for all of the attributes. In some cases, some of these attributes may be ignored and will be a subset of the attributes. The approach further comprises identifying the first record and the second record as being the same entity if the average matching score is greater than a predetermined matching score upper threshold. In such a case, the average matching score is paired to the predetermined matching score upper threshold and, if the average matching score is larger, the two records are considered to be a match. This enables some records to be more accurate and some records to be less accurate while still achieving a match.

In another embodiment, the approach further comprises identifying the first record and the second record as being different entities if the average matching score is less than a predetermined matching score lower threshold. If the average of the matching score is so low that the average of the matching score is below the predetermined matching score lower threshold, then the approach determines that the records are non-matching or do not match. This approach may provide for a more accurate means of determining if the first and second records are non-matching.

In another embodiment, the predetermined matching score upper threshold is identical to the predetermined matching score lower threshold. In such an embodiment, the upper and lower thresholds are identical and the algorithm reverts to a binary sorting case; the record is either identified as being different entities or identical entities. Such an embodiment may have the benefit of being used to implement a fully automated system.

In another embodiment, the approach further comprises scheduling a clerical task if the weighted matching score for each of the attributes is (i) greater than the predetermined matching score lower threshold and (ii) less than the predetermined matching score upper threshold. This is considered to be a boundary where the two records may, or may not, be identical. In such a case, a clerical task is created. In some examples, the clerical task could be the scheduling of an operator or user to review the two records and determine if the two records are identical or non-matching. In other examples, the clerical task could be the creation of a task in a time management or calendar system that instructs an operator or user to compare the first record and the second record. Such an embodiment may have the benefit of enabling full automation of the determination if the first and second record do represent the same entity.

In another embodiment the approach further comprises calculating an average quality rating by averaging the first individual quality rating for the attributes of the first record and the second individual quality rating for the attributes of the second record. The approach further comprises scheduling a clerical task if the average quality rating is below a predetermined quality rating value threshold. This step may, for example, be performed even before the matching scores are calculated. If the average quality of the data is so poor, then in this step the clerical task may be performed. Skipping the rest of the matching algorithm when the data quality is low may reduce the computational overhead and accelerate applying the approach to a large number of first and second records.

In another embodiment, the approach further comprises receiving a first data lineage graph for the attributes of the first record. The first data lineage graph comprises a first set of nodes. Each of the first set of nodes comprises a first node score. The approach further comprises receiving a second data lineage graph for the attributes of the second record. The second data lineage graph comprises a second set of nodes. Each of the set of said second set of nodes comprises a second node score.

The approach further comprises calculating the first individual quality rating for the attributes of the first record by tracing a first path through the first set of nodes and multiplying together the first node score for each of the first set of nodes that are members of the first path. For each attribute, a path is traced through the first set of nodes and the values that are accumulated, by going through this first set of nodes, are multiplied together to calculate the first individual quality rating. This may be done for each attribute of the first record.

The approach further comprises calculating the second individual quality rating for the attributes of the second record by tracing a second path through the second set of nodes and multiplying together the second set of node scores, for each of the second set of nodes, that are members of the second path. As was done for the first set of nodes, for each attribute of the second record, one may trace a path through the second set of nodes and then multiply the accumulated node scores by one another to calculate the second individual quality rating. Such an embodiment may be beneficial by separately calculating the first individual quality rating and/or the second individual quality rating accurately for each of the attributes.

In another embodiment, the approach further comprises receiving a first individual attribute validity score for the attributes of the first record. The calculating of the first individual quality rating score comprises weighting the first individual quality rating by the first individual attribute validity score. The approach further comprises receiving a second individual attribute validity score for the attributes of the second record. Calculating the second individual quality rating comprises weighting said second individual quality rating by the second individual attribute validity score. The first individual attribute validity score and the second individual attribute validity score may be scores which provide a measure of how many records or attributes, within each of the records, are accurate and provides an additional means of improving the estimate of the weighted matching score. This, for example, may make the algorithm more accurate and robust than conventional techniques.

In another embodiment the approach further comprises assigning the first node score to each of the first set of nodes. The approach further comprises assigning the second node score to each of the second set of nodes. The assigning of the first node score and the second node score may be achieved in different ways. In one example, the assigning may be done via a user interface or manual data entry. In other examples the assigning of the first node score and the second node score may be performed by an automatic algorithm. Embodiments of the present invention may be implemented using a computing device that may also be referred to as a computer system, a client, or a server. This embodiment may be beneficial because it may, for example, enable the use of prior knowledge about the first set of nodes and/or the second set of nodes to improve assessment if the first record and the second record represent the same entity.

Referring now to FIG. 1, a schematic of an example of a computer system is shown. Computer system 10 is only one example of a suitable computer system and is not intended to suggest any limitation as to the scope of use or functionality of embodiments of the invention described herein. Regardless, computer system 10 is capable of being implemented and/or performing any of the functionality set forth herein.

In computer system 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network personal computers (PCs), minicomputer systems, mainframe computer systems, and distributed computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on, that perform particular tasks or implement particular abstract data types. Computer system/server 12 may be practiced in distributed computing environments where tasks are performed by remote processing devices that are linked through a communications network. In a distributed computing environment, program modules may be located in both local and remote computer system storage media including, for example, memory storage devices.

As shown in FIG. 1, computer system/server 12 in computer system 10 is shown in the form of a general-purpose computing device. The components of computer system/server 12 may include, but are not limited to, one or more processors or processing units 16, a system memory 28, and a bus 18 that couples various system components including system memory 28 to processor 16. Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media and removable and non-removable media.

System memory 28 can include computer system readable media in the form of volatile memory, such as Random Access Memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

A computer system such as the computer system 10 shown in FIG. 1 may be used for performing operations disclosed herein such assessing if a first record and a second record, from at least two data sources, represent a same entity. Such a computer system may be a standalone computer with no network connectivity that may receive data to be processed through a local interface. Such operation may, however, likewise be performed using a computer system that is connected to a network such as a communications network and/or a computing network.

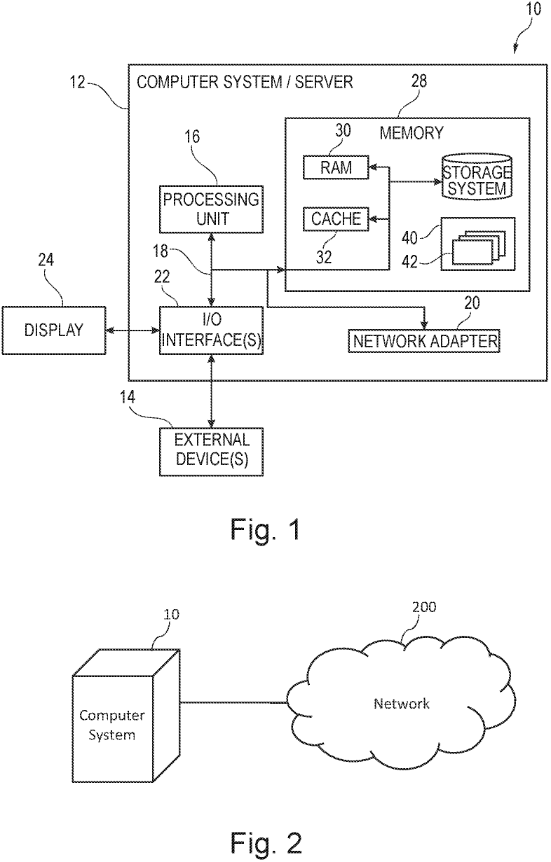

FIG. 2 shows an exemplary computing environment where a computer system, such as computer system 10, is connected, e.g., using the network adapter 20, to a network 200. Without limitation, the network 200 may be a communications network such as the internet, a local-area network (LAN), a wireless network such as a mobile communications network, and the like. The network 200 may comprise a computing network such as a cloud-computing network. The computer system 10 may receive data to be processed, such as two or more records, from the network 200 and/or may provide a computing result, such as determination if the two or more records represent the same entity, to another computing device connected to the computer system 10 via the network 200.

The computer system 10 may perform operations described herein, entirely or in part, in response to a request received via the network 200. In particular, the computer system 10 may perform such operations in a distributed computation together with one or more further computer systems that may be connected to the computer system 10 via the network 200. For that purpose, the computing system 10 and/or any further involved computer systems may access further computing resources, such as a dedicated or shared memory, using the network 200.

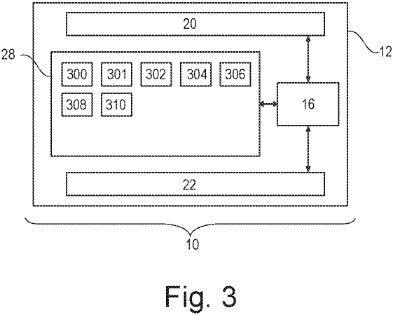

FIG. 3 illustrates an example of computer system 10. The computer system 10 illustrated in FIG. 3 is a representation of the computer system illustrated in FIG. 1. The processing unit 16 is shown as being connected to the network adaptor 20, the 10 interface 22 and the memory 28. The memory 28 is intended to represent the various types of memory that may be accessible to the processing unit 16.

The memory 28 is shown as containing program instructions 301. The program instructions enable the processing unit 16 to perform various functions such as performing data analysis and numerical tasks.

The memory 28 is further shown as containing a first record 300. The first record 300 comprises attributes. The memory 28 is further shown as containing a second record 302 that has the same attributes as the first record 300. The memory 28 is further shown as containing a first individual quality rating 304 for each attribute of the first record 300. The memory 28 is further shown as containing a second individual quality rating 306 for each attribute of the second record 302.

The memory 28 is further shown as containing a probabilistic matching engine 308. The probabilistic matching engine 308 receives the first record 300 and the second record 302 as input and then outputs a matching score 310 for each attribute. The matching score 310 may be considered to be a probability that an individual attribute matches between the first record 300 and the second record 302. The memory 28 is further shown as containing a weighted matching score 312 for each attribute. The weighted matching score 312 for each attribute, for example, may be calculated by taking the matching score for each attribute 310 and multiplying the matching score for each attribute 310 by an average of the first individual quality rating 304 and the second individual quality rating 306, for the respective attribute.

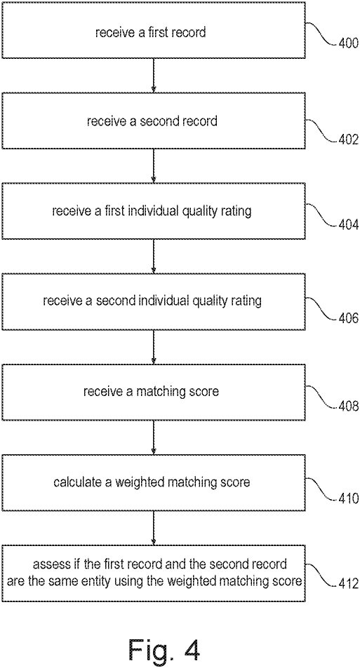

FIG. 4 shows a flowchart which illustrates an approach of operating the computer system 10 illustrated in FIG. 3. First, in step 400, a processor receives the first record 300. Next, in step 402, a processor receives the second record 302. In step 404, a processor receives the first individual quality rating 304. In step 406, a processor receives the second individual quality rating 306. In step 408, in response to inputting the first record 300 and the second record 302 into the probabilistic matching engine 308, a processor receives the matching score for each attribute 310. In step 410, a processor calculates the weighted matching score 312 by weighting the matching score for each of the attributes with the first individual quality rating 304 and the second individual quality rating 306. In step 412, a processor assesses if the first record 300 and the second record 302 represent the same entity based on the weighted matching score 312.

MDM systems may identify duplicate records and possibly resolve duplicate records, if applicable. Records in MDM can come from various sources. Today, such a process is known as matching and uses deterministic and/or probabilistic matching techniques with fuzzy operators such as phonetics, edit distance, nick name resolution, etc.

While survivorship rules have been exploiting priority rules by source, this has not been applied to the scoring of the records for determining the match results. Current approaches do not consider any information about what is known, how the input dataset are created, and how we are confident about records values in relation to the quality of the processes created these values.

Data lineage graphs can model all of the components involved in the process of generating attribute values used for matching problems and can reflect valuable information about how such values are trustful based on our domain knowledge about such processes. The new score (the weighted matching score 312) can be calculated based on that information (the matching score 310) to be combined with similarity scores (the first individual quality rating 304 and the second individual quality rating 306) to give better judgement about matching results.

Some examples may provide for a system that reduces the autonomy of the automatic matching engine when the data quality is low and increase the autonomy of the automatic matching engine when the data quality is high. Some examples may reduce the number of false negatives and false positives in matching due to low data quality. Some examples may increase the number of auto matching when the compared records that come from trustworthy data sources.

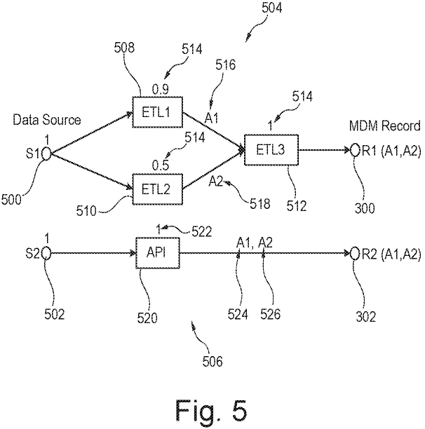

FIG. 5 illustrates a first data lineage graph 504 and a second data lineage graph 506. The first data lineage graph 504 shows the data lineage between a first data source 500 and the first record 300. The second data lineage graph 506 shows the data lineage between a second data source 502 and the second record 302.

The first data lineage graph 504 is shown as comprising three Extract, Transform and Load (ETL) nodes 508, 510, 512. A1 516 represents the attribute of the first record 516. A2 518, represents attribute 2 518 of the first record 300. Each of the data notes 508, 510, 512 has its own first node score 514.

The second data lineage graph 506 only shows a single API 520 between the second data source 502 and the second record 302. The API node 520 has its own second node score 522. A1 524 represents the attribute of the second record 524 and the attribute A2 526 represents attribute 2 for the second record 302.

The first individual quality rating 304 may be calculated by tracing the path from S1 to R1 for the attribute A1 516 and the attribute A2 518. It can be seen that these two different attributes have two different paths through the first data lineage graph 504 and will therefore have different first individual quality ratings 304.

In the second data lineage graph 506 there is only one path, so in this case the attribute 1 524 and the attribute 2 526 will have the same second individual quality rating 306 in this example.

An operator such as a Domain Expert or Data Steward may assign score (first node score 514, second node score 522) from zero to one to each node 508, 510, 512, 520 (ETL job, API, etc.) in the linage graph 504, 506 where each attribute 516, 518, 524, 526 passes through. This score is a relative measure among the graph that represents the understanding about the quality of that node. The scores will be the input to calculate the Source-attribute Data Quality (SADQ) for each attribute. SADQ is equivalent to the first individual quality rating 304 and the second individual quality rating 306. The average of the SADQ for a particular attribute averaged over all data sources is denoted as SADQ_A.

Using the example illustrated in FIG. 5, assume the following two sets of records R1 300, R2 302 (for the same entity type) each has two attributes A1 (516 and 524), A2 (518 and 526) and sourced from different two data sources S1 500 and S2 502 with the following data linage graph.

The SADQ calculation (calculation of the first individual quality rating 304 and the second individual quality rating 306) may be performed by multiplying all assigned scores (matching score 310) and percentage of valid records (first individual quality rating 304 and second individual quality rating 306):

$$\text{SADQ for} \left(\text{A1, S1}\right) = \text{SADQ\_1\_1=1*} 0.9 * 1 * 0.9 = 0.81$$

$$\text{SADQ for} \left(\text{A2, S1}\right) = \text{SADQ\_2\_1=1*} 0.5 * 1 * 0.7 = 0.35$$

$$\text{SADQ for} \left(\text{A1, S2}\right) = \text{SADQ\_1\_2=1*} 1 * 0.9 = . 0.9$$

$$\text{SADQ for} \left(\text{A2, S2}\right) = \text{SADQ\_2\_2=1*} 1 * 0.8 = 0.8$$

$$\text{SADQ\_A for A1=} \left(\text{SADQ\_1\_1+SADQ\_1\_2}\right) / 2 = \left(0.81 + 0.9\right) / 2 = 0.85$$

$$\begin{matrix}\text{SADQ\_A} \text{for} \text{A2} \text{=} \left(\text{SADQ\_2\_1} \text{+} \text{SADQ\_2\_2}\right) \text{/2} \text{=} \\ \left(\text{0} \text{.35} \text{+} \text{0} \text{.8}\right) \text{/2} \text{=} \text{0} \text{.58}\end{matrix}$$

Attribute Analysis in MDM data base may also be performed:
Percentage of valid records for attribute A1 for source S1 = 0.9
Percentage of valid records for attribute A2 for source S1 = 0.7
Percentage of valid records for attribute A1 for source S2 = 0.9
Percentage of valid records for attribute A2 for source S2 = 0.8

Source-entity type Data Quality (SEDQ) is the average quality rating value. One way of calculating SEDQ is by calculating the average of SADQ values for all attributes of an entity E:

$$\begin{matrix}\text{SEDQ} \text{for} \left(\text{E1,} \text{S1}\right) \text{=} \text{SEDQ\_1\_1} \text{=} \\ \left(\text{SADQ\_1\_1} \text{+} \text{SADQ\_2\_1}\right) \text{/2} \text{=} \left(\text{0} \text{.81} \text{+} \text{0} \text{.35}\right) \text{/2=0} \text{.58}\end{matrix}$$

$$\begin{matrix}\text{SEDQ} \text{for} \left(\text{E1,S2}\right) \text{=} \text{SEDQ\_1\_2} \text{=} \\ \left(\text{SADQ\_1\_2} \text{+} \text{SADQ\_2\_2}\right) \text{/2} \text{=} \left(\text{0} \text{.9} \text{+} \text{0} \text{.8}\right) \text{/2} \text{=} 0.85\end{matrix}$$

$$\begin{matrix}\text{SEDQ} \text{for} \text{entity} \text{E1} \text{=} \\ \left(\text{SEDQ\_1\_1} \text{+} \text{SEDQ\_1\_2}\right) \text{/2} \text{=} \left(\text{0} \text{.58} \text{+} \text{0} \text{.85}\right) \text{/2}\end{matrix}$$

In this example, the quality score of (A2, S1) is low mainly due to ETL2 assigned score. This also impacts the whole score calculated for that entity for source 1. The data steward could decide about matching results that use a source/entity/attribute combination)

The following table details the data source quality (first individual quality rating 304 and the second individual quality rating 306) for each attribute. The first individual quality rating 304 corresponds to the SADQ_n_1 entries. The second individual quality rating 306 corresponds to the SADQ_n_2 entries.

| | | | | | |
|---|---|---|---|---|---|
| | Attribute 1 | Attribute 2 | ... | Attribute n | SEDQ_E_S |
| Source 1 | SADQ_1_1 | SADQ_2_1 | ... | SADQ_n_1 | SEDQ_1_1 |
| Source 2 | SADQ_1_2 | SADQ_2_2 | ... | SADQ_n_2 | SEDQ_1_2 |
| SADQ A Confidence Score | SADQ_1 | SADQ_2 | ... | SADQ n | |

The SADQ_n values may, for example be an average of the SADQ_n_1 and SADQ_n_2 values.

The following table contains the matching scores 310 provided by the probabilistic matching engine 308.

| | | | | |
|---|---|---|---|---|
| | Attribute 1 | Attribute 2 | ... | Attribute n |
| Record_1 | Attribute Value 1,1 | Attribute Value 1,2 | ... | Attribute Value 1,n |
| PME score | PMES_1 | PMES_2 | ... | PMES_n |

The weighted matching scores 312 may be calculated using the matching scores 310 (PMES_n) and the average SADQ_n value:

SADQ_1*PMES_1, SADQ _2*PMES_2, ..., SADQ _n*PMES_n.

The average matching score (MS) may be calculated by averaging the above values:

$$\begin{matrix}\text{MS} \text{=} \text{average} \\ \left(\text{SADQ\_1*PMES\_1,} \text{SADQ\_2*PMES\_2,} … \text{,} \text{SADQ\_n*PMES\_n}\right) \text{.}\end{matrix}$$

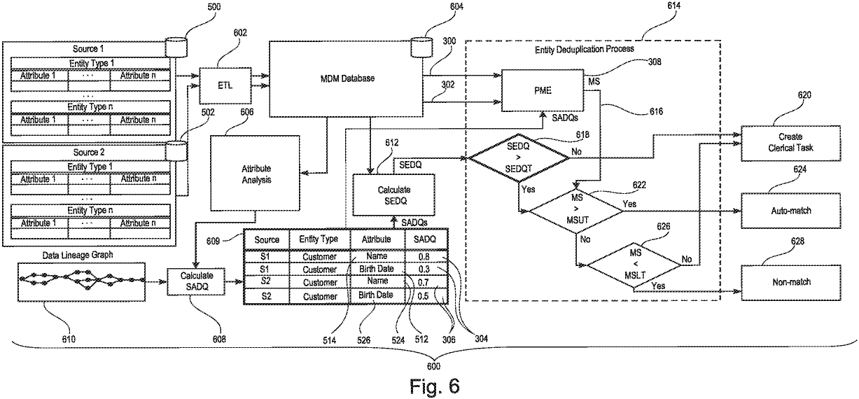

FIG. 6 shows a chart which illustrates an example of a system 600. The system 600 comprises a first data source 500 and a second data source 502 that are connected to an ETL module 602. The ETL module 602 feeds into a Master Data Management (MDM) database 604. The ETL module 602 is a data integration module that performs (ETL steps to blend data from multiple sources 500, 502. The MDM database 604 provides data to an attribute analysis module 606 that performs attribute analysis and provides data to an SADQ calculation module 608.

The SADQ calculation module 608 is a Source Attribute Data Quality (SADQ) module and is used to calculate the first individual quality rating (304) and the second individual quality rating (306) for the first record 300 and the second record 302 respectively. The SADQ calculation module 608 is able to reference a data lineage graphs 610 for each attribute of each record 300, 302. The output of the SADQ calculation module 602 is represented in the table 609. The table 609 shows the various data sources, the entity type, the attribute and the SADQ (The first individual quality rating 304 and the second individual quality rating 306).

The SADQ for source 1 is the first individual quality rating 304 for each attribute of the first record. The SADQ for the second individual quality rating 306 or each attribute of the second record 302 is also shown in the table 609. The SADQs can be provided to an SEDQ module 612. The SEDQ is the source entity type data quality which is an average of all of the SADQs. The SEDQ is also referred to herein as an average quality rating value.

The system 600 is also shown as comprising an entity duplication detection module 614. The entity duplication detection module 614 takes as input the first record 300 and the second record 302. The entity duplication detection module 614 also takes the SEDQ or average quality rating value as input. It also takes the SADQs or the first individual quality rating 304 and the second individual quality rating 306 for each attribute as input. The entity duplication detection module 614 comprises a probabilistic matching engine 308 which compares each entity of the first record 300 and the second record 302 and provides a matching score 310 for each attribute.

The SADQs or the first individual quality ratings 304 and second individual quality rating 306 are used with the matching score 310 to produce a weighted matching score for each attribute 312. After the weighted matching score for each attribute 312 is produced an average matching score 616 is calculated. These values are then used to determine whether the first record 300 and the second record 302 are match.

The approach proceeds to decision 618 and decides if the SADQ is greater than the SEDQ Threshold (SEDQT). The SEDQT is the predetermined quality rating value threshold. If a processor determines that the SADQ is not greater than the SEDQT (decision 618, no branch), then the approach proceeds to step 620 and a clerical task is scheduled or created. If a processor determines that the SADQ is greater than the SEDQT, (decision 618, yes branch), the approach proceeds to decision 622.

The determination made in decision 622 is whether MS is greater than the Matching Score Upper Threshold (MSUT). MSUT is equivalent to the predetermined matching score upper threshold. MS is the average matching score. If a processor determines that the MS is greater than the MSUT (decision 622, yes branch), the approach proceeds to step 624 and a processor determines that the first record 300 and the second record 302 match. In some embodiments, decision 622 may also be “is MS greater than or equal to MSUT.”

If a processor determines that the MS is not greater than the MUST (decision 622, no branch), the approach proceeds to decision 626. The determination made in decision 626 is “is MS less than the Matching Score Lower Threshold (MSLT).” MSLT is equivalent to the predetermined matching score lower threshold. If a processor determines that the MS is not less than the MSLT (decision 626, no branch), the approach proceeds to step 620 and a clerical task is scheduled or created. If a processor determines that the MS is less than the MSLT (decision 626, yes branch), the approach proceeds to step 628 and a processor determines that the first record 300 and the second record 302 do not match. In some embodiments, the inequality in decision 626 is “is MS less than or equal to MSLT.”

An example algorithm could comprise one or more of the following steps: Input: record and candidate, data lineage database, data quality score per attribute per data source.
Step 1: Calculate entity data quality 304, 306 of the data source 500, 502 for the entity type (SEDQ) based on the data lineage graph 610;
Step 2 (618): Is the data quality good enough for all data sources for that entity? (SEDQ > SEDQT)
   Yes: Step 2.1:
      Step 2.1.1: For each attribute:
         Step 2.1.1.1 : Calculate attribute data quality 304, 306 for each data source 500, 502 (SADQ);
         Step 2.1.1.2 : Calculate average attribute data quality over all data sources used in matching (SADQ_A);
         Step 2.1.1.3: Calculate matching score (PME);
         Step 2.1.1.4: Weight PME with attribute the data quality value (the lower the quality, less weight it should have for matching);
      Step 2.1.2: Calculate final matching score (MS, average matching score);
      Step 2.1.3: Make a matching recommendation (clerical 620, auto-match 624, non-match 628);
   No: Step 2.2: Create a clerical task 620.

A probabilistic matching engine as used herein encompasses an algorithm or matching engine that generates matching scores that use the frequency of the occurrence of a data value within a probability distribution. In matching records probabilistically, a number of different factors are taken into account. This may also be referred to as so-called fuzzy matching. A probabilistic matching engine therefore does not require that two records match exactly but that they have a high probability of being the same record. This may be particularly useful in cases where the same address or information may be entered in different forms and may also help to improve accuracy when there are errors or inconsistencies within the data.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
receiving, by one or more processors, a first record from a first data source, wherein the first record comprises attributes;
receiving, by one or more processors, a second record from a second data source, wherein the second record comprises said attributes;
receiving, by one or more processors, a first individual quality rating for the attributes of the first record;
receiving, by one or more processors, a second individual quality rating for the attributes of the second record;
in response to inputting the first record and the second record into a probabilistic matching engine, receiving, by one or more processors, a matching score for each of (i) the attributes of the first record and (ii) the attributes of the second record;
calculating, by one or more processors, a weighted matching score for each of (i) the attributes of the first record and (ii) the attributes of the second record by weighting the matching score for each of the respective attributes with the first individual quality rating and the second individual quality rating; and
assessing, by one or more processors, whether the first record and the second record represent a same entity based on the weighted matching score.

2. The computer-implemented method of claim 1, further comprising:
calculating, by one or more processors, an average matching score by averaging at least a subset of the weighted matching score for each respective attribute; and
identifying, by one or more processors, the first record and the second record as being the same entity based on the average matching score being greater than a predetermined matching score upper threshold.

3. The computer-implemented method of claim 2, further comprising identifying, by one or more processors, the first record and the second record as being different entities based on the average matching score being less than a predetermined matching score lower threshold.

4. The computer-implemented method of claim 3, wherein the predetermined matching score upper threshold is identical to the predetermined matching score lower threshold.

5. The computer-implemented method of claim 3, further comprising scheduling, by one or more processors, a clerical task based on the weighted matching score for each respective attribute being (i) greater than the predetermined matching score lower threshold and (ii) less than the predetermined matching score upper threshold.

6. The computer-implemented method of claim 1, further comprising:
calculating, by one or more processors, an average quality rating value by averaging the first individual quality rating for the attributes of the first record and the second individual quality rating for the attributes of the second record; and
scheduling, by one or more processors, a clerical task if the average quality rating is below a predetermined quality rating value threshold.

7. The computer-implemented method of claim 1, further comprising:
receiving, by one or more processors, a first data lineage graph for the attributes of the first record, wherein the first data lineage graph comprises a first set of nodes and each of the first set of nodes comprises a first node score;
receiving, by one or more processors, a second data lineage graph for the attributes of the second record, wherein the second data lineage graph comprises a second set of nodes and each of the second set of nodes comprises a second node score;
calculating, by one or more processors, the first individual quality rating for the attributes of the first record by tracing a first path through the first set of nodes and multiplying together the first node score for each of the first set of nodes that are members of the first path; and
calculating, by one or more processors, the second individual quality rating for the attributes of the second record by tracing a second path through the second set of nodes and multiplying together the second node score for each of the second set of nodes that are members of the second path.

8. The computer-implemented method of claim 7, further comprising:
receiving, by one or more processors, a first individual attribute validity score for the attributes of the first record, wherein calculating the first individual quality rating comprises weighting the first individual quality rating by the first individual attribute validity score; and
receiving, by one or more processors, a second individual attribute validity score for the attributes of the second record, wherein calculating the second individual quality rating comprises weighting the second individual quality rating by the second individual attribute validity score.

9. The computer-implemented method of claim 7, further comprising:
assigning, by one or more processors, the first node score to each of the first set of nodes, and
assigning, by one or more processors, the second node score to each of the second set of nodes.

10. A computer program product comprising:
one or more computer readable storage media, and program instructions collectively stored on the one or more computer readable storage media, the program instructions comprising:
program instructions to receive a first record from a first data source, wherein the first record comprises attributes;
program instructions to receive a second record from a second data source, wherein the second record comprises said attributes;
program instructions to receive a first individual quality rating for the attributes of the first record;
program instructions to receive a second individual quality rating for the attributes of the second record;
program instructions to, in response to inputting the first record and the second record into a probabilistic matching engine, receive a matching score for each of (i) the attributes of the first record and (ii) the attributes of the second record;
program instructions to calculate a weighted matching score for each of (i) the attributes of the first record and (ii) the attributes of the second record by weighting the matching score for each of the respective attributes with the first individual quality rating and the second individual quality rating; and
program instructions to assess whether the first record and the second record represent a same entity based on the weighted matching score.

11. The computer program product of claim 10, further comprising:
program instructions, collectively stored on the one or more computer readable storage media, to calculate an average matching score by averaging at least a subset of the weighted matching score for each respective attribute; and
program instructions, collectively stored on the one or more computer readable storage media, to identify the first record and the second record as being the same entity based on the average matching score being greater than a predetermined matching score upper threshold.

12. The computer program product of claim 11, further comprising program instructions, collectively stored on the one or more computer readable storage media, to identify the first record and the second record as being different entities based on the average matching score being less than a predetermined matching score lower threshold.

13. The computer program product of claim 12, wherein the predetermined matching score upper threshold is identical to the predetermined matching score lower threshold.

14. The computer program product of claim 12, further comprising program instructions, collectively stored on the one or more computer readable storage media, to schedule a clerical task based on the weighted matching score for each respective attribute being (i) greater than the predetermined matching score lower threshold and (ii) less than the predetermined matching score upper threshold.

15. The computer program product of claim 10, further comprising:
program instructions, collectively stored on the one or more computer readable storage media, to calculate an average quality rating value by averaging the first individual quality rating for the attributes of the first record and the second individual quality rating for the attributes of the second record; and
program instructions, collectively stored on the one or more computer readable storage media, to schedule a clerical task if the average quality rating is below a predetermined quality rating value threshold.

16. The computer program product of claim 10, further comprising:
program instructions, collectively stored on the one or more computer readable storage media, to receive a first data lineage graph for the attributes of the first record, wherein the first data lineage graph comprises a first set of nodes and each of the first set of nodes comprises a first node score;
program instructions, collectively stored on the one or more computer readable storage media, to receive a second data lineage graph for the attributes of the second record, wherein the second data lineage graph comprises a second set of nodes and each of the second set of nodes comprises a second node score;
program instructions, collectively stored on the one or more computer readable storage media, to calculate the first individual quality rating for the attributes of the first record by tracing a first path through the first set of nodes and multiplying together the first node score for each of the first set of nodes that are members of the first path; and
program instructions, collectively stored on the one or more computer readable storage media, to calculate the second individual quality rating for the attributes of the second record by tracing a second path through the second set of nodes and multiplying together the second node score for each of the second set of nodes that are members of the second path.

17. The computer program product of claim 16, further comprising:
program instructions, collectively stored on the one or more computer readable storage media, to receive a first individual attribute validity score for the attributes of the first record, wherein calculating the first individual quality rating comprises weighting the first individual quality rating by the first individual attribute validity score; and
program instructions, collectively stored on the one or more computer readable storage media, to receive a second individual attribute validity score for the attributes of the second record, wherein calculating the second individual quality rating comprises weighting the second individual quality rating by the second individual attribute validity score.

18. The computer program product of claim 16, further comprising:
program instructions, collectively stored on the one or more computer readable storage media, to assign the first node score to each of the first set of nodes, and
program instructions, collectively stored on the one or more computer readable storage media, to assign the second node score to each of the second set of nodes.

19. A computer system comprising:
one or more computer processors, one or more computer readable storage media, and program instructions collectively stored on the one or more computer readable storage media for execution by at least one of the one or more computer processors, the program instructions comprising:
program instructions to receive a first record from a first data source, wherein the first record comprises attributes;
program instructions to receive a second record from a second data source, wherein the second record comprises said attributes;
program instructions to receive a first individual quality rating for the attributes of the first record;
program instructions to receive a second individual quality rating for the attributes of the second record;
program instructions to, in response to inputting the first record and the second record into a probabilistic matching engine, receive a matching score for each of (i) the attributes of the first record and (ii) the attributes of the second record;
program instructions to calculate a weighted matching score for each of (i) the attributes of the first record and (ii) the attributes of the second record by weighting the matching score for each of the respective attributes with the first individual quality rating and the second individual quality rating; and
program instructions to assess whether the first record and the second record represent a same entity based on the weighted matching score.

20. The computer program product of claim 19, further comprising:
program instructions, collectively stored on the one or more computer readable storage media for execution by at least one of the one or more computer processors, to calculate an average matching score by averaging at least a subset of the weighted matching score for each respective attribute; and
program instructions, collectively stored on the one or more computer readable storage media for execution by at least one of the one or more computer processors, to identify the first record and the second record as being the same entity based on the average matching score being greater than a predetermined matching score upper threshold.
